(19) United States
(12) Patent Application Publication
(10) Pub. No.: US 2025/0118999 A1
(43) Pub. Date: Apr. 10, 2025

(54) RECOVERY FROM POWER INTERRUPTION IN WIRELESSLY POWERED APPLIANCE

(71) Applicant: Midea Group Co., Ltd., Beijiao (CN)

(72) Inventors: Craig Benjamin Williams, Louisville, KY (US); John Kenneth Hooker, Louisville, KY (US); Hieu Manh Vu, Louisville, KY (US)

(21) Appl. No.: 18/481,544

(22) Filed: Oct. 5, 2023

(51) Int. Cl. H02J 50/90; H02J 50/00

(52) U.S. Cl. CPC H02J 50/90; H02J 50/001

(57) ABSTRACT

An apparatus and method selectively resume an interrupted operation of a wirelessly powered appliance after an unintentional power loss. An interrupted operation may be selectively resumed, for example, based upon one or more of a detected movement (or lack of detected movement) of the wirelessly powered appliance, a detected temperature of and/or in the wirelessly powered appliance, and a detected fault in a wireless power transmitter and/or wireless power system that supplies power to the wirelessly powered appliance.

### BACKGROUND

A wide variety of kitchen appliances are commonly used in single-family and multi-family residential applications. Many of these appliances, e.g., dishwashers, wine coolers, refrigerators, laundry washing machines, ovens, ranges, cooktops, etc., are installed in a “built-in” fashion such as under a countertop, within a cut-out formed in the countertop, or in a designated opening in the arrangement of kitchen cabinets. Built-In appliances are often hard-wired into a household electrical circuit or are plugged in to a dedicated electrical outlet that is generally hidden from view when the appliance is in its installed location.

Many consumers, however, also rely on various smaller kitchen appliances to perform more specific tasks, including, for example, microwave ovens, rice cookers, blenders, mixers, food processors, toasters, air fryers, pressure cookers, coffee makers, espresso machines, etc. While sometimes these appliances are stored on the countertop when not in use, in other instances these appliances may be stored in the cabinets or elsewhere and brought out when needed. To power such devices, many kitchens include electrical outlets on the wall between the upper cabinets and the countertop, which is often referred to as a backsplash, so that such appliances may be plugged in when needed. The power cords used by such appliances, however, can be cumbersome and unsightly, both during use and in storage.

More recently, it has been proposed to use wireless power for smaller kitchen appliances, e.g., based upon the Ki Kitchen Cordless Standard developed by the Wireless Power Consortium. Rather than relying on a power cord plugged into an electrical outlet, a wirelessly-powered appliance includes a wireless power receiver that is oriented on the bottom of the appliance to receive power wirelessly from a wireless power transmitter that is embedded in a cooktop, a countertop or table when the appliance is positioned directly over the wireless power transmitter.

It is often desirable for wirelessly powered appliances to function in a similar manner their wired counterparts, given that many consumers may have years or decades of experience and familiarity with various types of wired appliances. One area where wirelessly powered appliances may differ from their wired counterparts, however, is how they react to a loss of power. With a wired appliance, for example, power is assumed to be available to the appliance whenever it is plugged in, so whenever the wired appliance is unplugged, it can be assumed that the appliance is fully off. Some consumers may even utilize the power cords of some types of wired appliances as de facto off switches, and may simply unplug an appliance whenever they are done using it rather than activate a separate on/off switch.

In addition, many households experience temporary power losses from time to time (e.g., due to weather, utility work, etc.). These temporary losses can be relatively short in some instances, e.g., only a few minutes in duration, and even as short as a second or two. It can be assumed that if household power is temporarily lost, power will be restored to a wired appliance whenever the household power returns, as long as the appliance remains plugged in. For a wired appliance that a consumer is actively monitoring and operating when a power loss occurs (e.g., a blender), the consumer may recognize that power is lost, and may unplug the appliance to ensure that it does not turn on unexpectedly when power is restored. Likewise, for a wired appliance that may be unattended (e.g., a slow cooker), a temporary power loss may not present a particular concern, since the appliance can immediately resume operation once power is restored.

Replicating the aforementioned behaviors of wired appliances in wirelessly powered appliances, however, can be problematic. Many wirelessly powered appliances, for example, lack any secondary source of power such as an onboard battery, and as such may immediately shut off any time wireless power is lost, regardless of whether the wireless power loss was intentional (e.g., the consumer removed the wirelessly powered appliance from the wireless power transmitter) or unintentional (e.g., a temporary power loss occurred). Moreover, many wirelessly powered appliances are designed to start up the same way whenever they initially power on, and regardless of their operational state when they were shut off. Generally, this initial state is one in which the appliance is ready to perform operations, but is not actively performing any operations, including any operations that were being performed when the appliance was last used. In part, this behavior is driven by the fact that, similar to how some consumers may turn a wired appliance off simply by unplugging the appliance, some consumers may also turn a wirelessly powered appliance off simply by removing the wirelessly powered appliance from a wireless power transmitter and putting it away in storage. It would be undesirable for many types of wirelessly powered appliances, e.g., blenders, food processors, etc., to automatically resume a previous operation when the consumer pulled the wirelessly powered appliance out of storage days or weeks later and placed it on a wireless power transmitter.

Therefore, with respect to temporary and other unintentional power losses, many wirelessly powered appliances will, upon restoration of power, restart without resuming any operations that were interrupted as a result of a temporary power loss. For wirelessly powered appliances that a consumer actively monitors during use, restarting such appliances without resuming interrupted operations may be desirable (e.g., for a wirelessly powered blender, it may not be desirable for the blender to immediately turn back on whenever power is restored). However, for other wirelessly powered appliances that are generally unattended during use, restarting such appliances without resuming interrupted operations may present significant concerns. Consider, for example, a slow cooker that performs a cooking operation over several hours while a consumer is at work so that a meal is ready when the consumer returns home. If a temporary power loss of a few seconds or minutes occurs relatively early in the cooking operation, the slow cooker could potentially halt operation without resuming, which at best, results in an incomplete cooking operation, and at worst, results in a potential food safety issue, e.g., if raw meat in the slow cooker is allowed to sit at room temperature for several hours after the cooking operation has been halted.

As such, a significant need exists in the art for a manner of enabling a wirelessly powered appliance, in appropriate circumstances, to resume interrupted operations after an unintentional power loss.

### SUMMARY

The herein-described embodiments address these and other problems associated with the art by providing an apparatus and method for selectively resuming an interrupted operation of a wirelessly powered appliance after an unintentional power loss. A wirelessly powered appliance may selectively resume an operation interrupted by an unintentional power loss, for example, based upon one or more of a detected movement (or lack of detected movement) of the wirelessly powered appliance, a detected temperature of and/or in the wirelessly powered appliance, and a detected fault in a wireless power transmitter and/or wireless power system that supplies power to the wirelessly powered appliance.

Therefore, consistent with one aspect of the invention, an apparatus may include one or more processors, and one or more memories storing instructions that, when executed by the one or more processors, selectively resume an interrupted operation of a wirelessly powered appliance after an unintentional power loss by, during startup of the wirelessly powered appliance determining the interrupted operation being performed by the wirelessly powered appliance when power was lost by the wirelessly powered appliance, determining whether the power was lost by the wirelessly powered appliance as a result of movement of the wirelessly powered appliance, determining whether to resume the determined interrupted operation based at least in part on the determination of whether the power was lost by the wirelessly powered appliance as the result of movement of the wirelessly powered appliance, and causing the wirelessly powered appliance to automatically resume the interrupted operation based at least in part on the determination of whether to resume the determined interrupted operation.

In some embodiments, at least one of the one or more memories and at least one of the one or more processors are disposed in the wirelessly powered appliance. Also, in some embodiments, at least one of the one or more memories and at least one of the one or more processors are disposed in a wireless power system that supplies wireless power to the wirelessly powered appliance. In addition, some embodiments may further include non-volatile storage, and the instructions are configured to selectively resume the interrupted operation of the wirelessly powered appliance after the unintentional power loss further by storing movement data captured by a motion sensor of the wirelessly powered appliance during performance of the interrupted operation and prior to the startup of the wirelessly powered appliance, and to determine whether the power was lost by the wirelessly powered appliance as a result of movement of the wirelessly powered appliance by accessing the non-volatile storage during startup of the wirelessly powered appliance.

Further, in some embodiments, the motion sensor includes an accelerometer, a gyroscope, and/or an inclinometer. Some embodiments may further include non-volatile storage, and the instructions are configured to selectively resume the interrupted operation of the wirelessly powered appliance after the unintentional power loss further by storing first harvested power data associated with alignment of the wireless power transmitter and a wireless power receiver of the wirelessly powered appliance prior to the loss of power of the wirelessly powered appliance, and to determine whether the power was lost by the wirelessly powered appliance as a result of movement of the wirelessly powered appliance by accessing the non-volatile storage during startup of the wirelessly powered appliance to compare the first harvested power data with second harvested power data associated with alignment of the wireless power transmitter and a wireless power receiver of the wirelessly powered appliance after the loss of power of the wirelessly powered appliance.

Some embodiments may also include non-volatile storage, and the instructions are configured to selectively resume the interrupted operation of the wirelessly powered appliance after the unintentional power loss further by storing operational state data for the wirelessly powered appliance during performance of the interrupted operation and prior to the startup of the wirelessly powered appliance, and to determine the interrupted operation being performed by the wirelessly powered appliance when power was lost by the wirelessly powered appliance by accessing the non-volatile storage during startup of the wirelessly powered appliance.

In addition, in some embodiments, the instructions are configured to determine whether to resume the determined interrupted operation based at least in part on the determination of whether the power was lost by the wirelessly powered appliance as a result of movement of the wirelessly powered appliance by determining to resume the determined interrupted operation if the wirelessly powered appliance is determined to not have been in motion when power was lost by the wirelessly powered appliance, and determining to not resume the determined interrupted operation if the wirelessly powered appliance is determined to have been in motion when power was lost by the wirelessly powered appliance.

In some embodiments, the wirelessly powered appliance is a kitchen appliance including at least one electrical load, the at least one electrical load includes an electric motor, a solenoid, a cooling element, or a heating element, and the interrupted operation uses the at least one electrical load during performance of the interrupted operation. In addition, in some embodiments, the instructions are further configured to determine a duration from when power was lost by the wirelessly powered appliance, and the instructions are configured to determine whether to resume the determined interrupted operation further based at least in part on the determined duration. Moreover, in some embodiments, the instructions are further configured to determine a temperature on or in the wirelessly powered appliance and determine whether the power loss was a result of a fault in a wireless power transmitter that supplies power to the wirelessly powered appliance, and the instructions are configured to determine whether to resume the determined interrupted operation further based at least in part on the determined temperature and the determination of whether the power loss was the result of a fault in the wireless power transmitter.

Consistent with another aspect of the invention, an apparatus may include one or more processors, and one or more memories storing instructions that, when executed by the one or more processors, selectively resume an interrupted operation of a wirelessly powered appliance after an unintentional power loss by, during startup of the wirelessly powered appliance determining the interrupted operation being performed by the wirelessly powered appliance when power was lost by the wirelessly powered appliance, determining a temperature on or in the wirelessly powered appliance, determining whether to resume the determined interrupted operation based at least in part on the determined temperature, and causing the wirelessly powered appliance to automatically resume the interrupted operation based at least in part on the determination of whether to resume the determined interrupted operation.

In some embodiments, the interrupted operation is a cooking operation that heats food using the wirelessly powered appliance. Moreover, in some embodiments, the determined temperature is a temperature captured by a temperature sensor of the wirelessly powered appliance after power was lost by the wirelessly powered appliance. In some embodiments, the instructions are configured to determine whether to resume the determined interrupted operation based at least in part on the determined temperature by determining to resume the determined interrupted operation in response to the determined temperature meeting a predetermined temperature threshold. In addition, in some embodiments, the predetermined temperature threshold is associated with a food safety temperature.

In some embodiments, the temperature is a first temperature, the instructions are further configured to determine a second temperature on or in the wirelessly powered appliance before power was lost by the wirelessly powered appliance, and the instructions are configured to determine whether to resume the determined interrupted operation based at least in part on the determined temperature by determining a temperature change from between the first and second temperatures.

Consistent with another aspect of the invention, an apparatus may include one or more processors, and one or more memories storing instructions that, when executed by the one or more processors, selectively resume an interrupted operation of a wirelessly powered appliance after an unintentional power loss by, during startup of the wirelessly powered appliance determining the interrupted operation being performed by the wirelessly powered appliance when power was lost by the wirelessly powered appliance, determining whether the power loss was a result of a fault in a wireless power transmitter that supplies power to the wirelessly powered appliance, determining whether to resume the determined interrupted operation based at least in part on the determination of whether the power loss was the result of a fault in the wireless power transmitter, and causing the wirelessly powered appliance to automatically resume the interrupted operation based at least in part on the determination of whether to resume the determined interrupted operation.

Moreover, in some embodiments, the instructions are configured to determine whether the power loss was the result of a fault in a wireless power transmitter that supplies power to the wirelessly powered appliance by determining that the power loss was the result of a power loss by the wireless power transmitter. In addition, some embodiments may further include non-volatile storage, and the instructions are configured to selectively resume the interrupted operation of the wirelessly powered appliance after the unintentional power loss further by storing fault data associated with the fault in the wireless power transmitter prior to the startup of the wirelessly powered appliance, and to determine whether the power loss was the result of a fault in the wireless power transmitter by accessing the non-volatile storage during startup of the wirelessly powered appliance.

Other embodiments may include various methods for making and/or using any of the aforementioned constructions and/or various devices, systems, or apparatuses for performing any the aforementioned operations.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a room incorporating an undercounter wireless power system consistent with some embodiments of the invention.

FIG. 2 is a top plan view of the countertop and wireless power system of FIG. 1.

FIG. 3 is a block diagram of an example control system for the wireless power system and wirelessly powered appliance of FIG. 1.

FIG. 4 is a block diagram of example timer circuit for the wirelessly powered appliance of FIGS. 1 and 3.

FIG. 5 is a flowchart illustrating an example operational sequence for selectively resuming an interrupted operation of the wirelessly powered appliance of FIGS. 1 and 3.

FIG. 6 is a flowchart illustrating an example operation sequence for persisting an operation mode of the wirelessly powered appliance of FIGS. 1 and 3.

FIG. 7 is a flowchart illustrating an example operation sequence for persisting a temperature for the wirelessly powered appliance of FIGS. 1 and 3.

FIG. 8 is a flowchart illustrating an example operation sequence for persisting fault data in the wirelessly powered appliance of FIGS. 1 and 3.

FIG. 9 is a flowchart illustrating an example operational sequence for persisting movement data in the wirelessly powered appliance of FIGS. 1 and 3.

FIG. 10 is a flowchart illustrating an example operational sequence for selectively resuming an interrupted operation of the wirelessly powered appliance of FIGS. 1 and 3 based upon harvested power data.

FIG. 11 is a flowchart illustrating an example operational sequence for selectively resuming an interrupted operation of the wirelessly powered appliance of FIGS. 1 and 3 based upon temperature data.

FIG. 12 is a flowchart illustrating an example operational sequence for selectively resuming an interrupted operation of the wirelessly powered appliance of FIGS. 1 and 3 based upon fault data.

### DETAILED DESCRIPTION

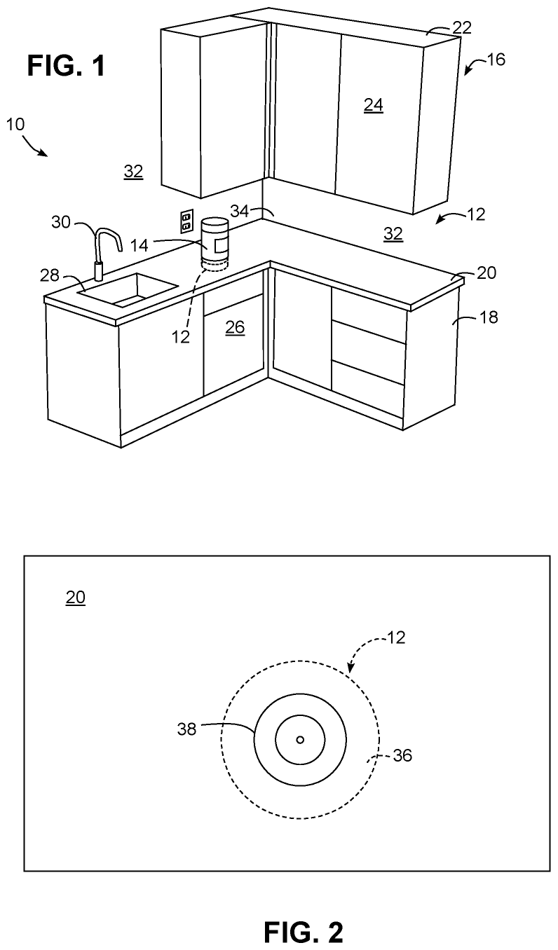

Turning now to the drawings, wherein like numbers denote like parts throughout the several views, FIG. 1 illustrates an example room (e.g., a kitchen) 10 within which is installed an undercounter wireless power system 12 suitable for powering one or more wirelessly powered appliances, e.g., a wirelessly powered appliance 14 implemented as a pressure cooker. Room 10 includes a built-in cabinet system 16, which includes one or more base cabinets 18 that support a countertop 20 and one or more upper or wall cabinets 22 that are positioned over countertop 20. Cabinets 18, 22 may include doors, e.g., door 24, in some instances, or may include drawers or open shelves, and it will be appreciated that in some instances, various built-in appliances (e.g., dishwasher 26) may also be mounted or positioned within built-in cabinet system 16 (other appliances include, but are not limited to, refrigerators, ovens, ranges, cooktops, laundry washing machines, dryers, etc.) One or more sinks 28 may also be disposed on countertop 20 and may be supplied with water by a faucet 30.

Cabinets 18, 22 are generally secured along one or more walls 32 in room 10, with wall cabinets 22 generally mounted to walls 32 and positioned above counter height, e.g., above countertop 20, which is supported by base cabinets 18. In the United States, for example, the countertop may be at a height (from the floor) of approximately 36 inches with the wall cabinets at a height (from the floor) of approximately 54 inches, such that the wall area between the countertop and the bottom of the wall cabinets, referred to herein as a backsplash 34, has a height (from the countertop to the bottom of the wall cabinets) of approximately 18 inches. Base cabinets 18 may or may not be secured to walls 32, but are otherwise generally floor standing such that their load is predominantly borne by the floor rather than a wall, which is generally the case for wall cabinets 22.

It will be appreciated that other countertop, wall cabinet, and backsplash heights may be used in other embodiments. It will also be appreciated that room 10 may be any suitable indoor or outdoor living or working space within which it may be desirable to use a wirelessly powered appliance, including rooms lacking any built-in cabinets or countertops. Example types of suitable rooms include a kitchen, bar, entertainment area, bedroom, office area, retail establishment, etc. In some embodiments, room 10 may even be disposed within a boat or recreational vehicle.

With additional reference to FIG. 2, wireless power system 12 may include a wireless power transmitter 36 mounted underneath countertop 20. Furthermore, it will be appreciated that, due to the opaque nature of countertop 20, it may not be readily apparent to a user where exactly the wireless power transmitter 36 is located, so it may be desirable to place some indicator 38 on the top surface of countertop 20 to assist a user in properly positioning a wirelessly powered appliance over the wireless power transmitter. Indicator 38 may be formed on countertop 20 in a number of manners, e.g., via adhesives (such as where the indicator is a sticker), paint, etching, fasteners, etc. Furthermore, indicator 38 may take various forms, e.g., concentric rings, cross-hairs, or even a simple point or dot. The size of the indicator may also vary in different embodiments, and in some embodiments, may be large enough such that the outer perimeter of the indicator is still visible when the wirelessly powered appliance is positioned over the wireless power transmitter. An indicator may also be projected in some embodiments, e.g., downwardly from a light source positioned underneath a wall cabinet 22.

While wireless power transmitter 36 is positioned underneath a countertop 20 in FIGS. 1-2, it will be appreciated that a wireless power transmitter may be disposed underneath other surfaces and thus effectively hidden from view in other embodiments, e.g., a shelf, a piece of furniture, or a floor, among others. In addition, in some embodiments a wireless power transmitter may not be disposed underneath a horizontal surface, and as such, may be positioned behind a wall or other non-horizontal surface. In addition, a wireless power transmitter may be disposed on top of a surface in some embodiments, or may be mounted and/or supported on various structures, including backsplashes, cabinets, furniture, etc. A wireless power transmitter may also be integrated into another appliance in some embodiments, e.g., as part of a stovetop, oven or range, and in some embodiments, a wireless power transmitter may be disposed in a standalone housing. Other suitable configurations will be appreciated by those of ordinary skill having the benefit of the instant disclosure.

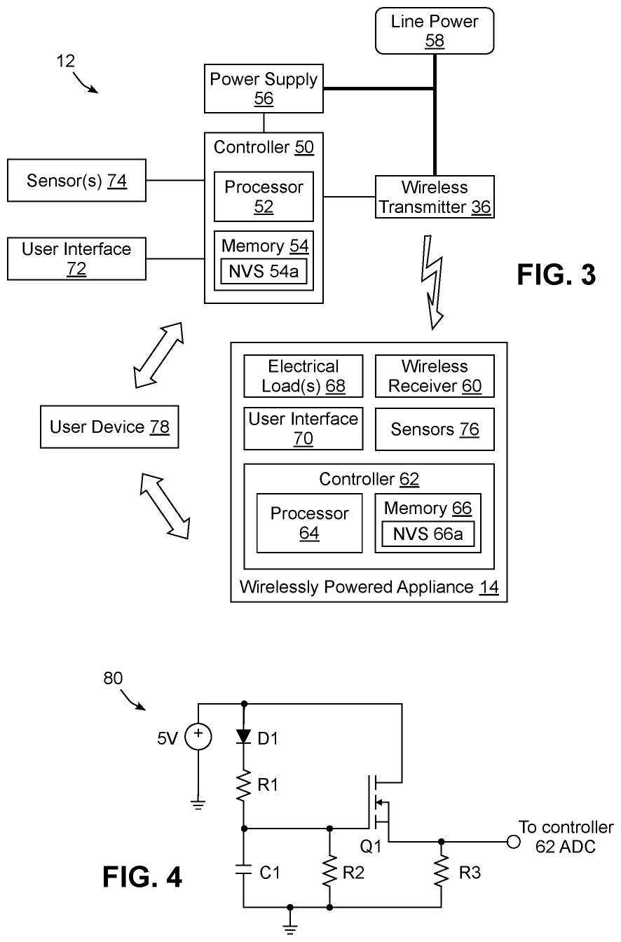

Now turning to FIG. 3, wireless power system 12 may be under the control of a controller 50 that receives inputs from a number of components and drives a number of components in response thereto. Controller 50 may, for example, include one or more processors 52 and one or more memories 54 within which may be stored program code for execution by the one or more processors. The memories may be embedded in controller 50, but may also be considered to include volatile and/or non-volatile memories, cache memories, flash memories, programmable read-only memories, read-only memories, etc., as well as memory storage physically located elsewhere from controller 50, e.g., in a mass storage device or on a remote computer interfaced with controller 50. Controller 50 may also be implemented at least in part using discrete circuit logic, as will be appreciated by those of ordinary skill having the benefit of the instant disclosure.

As shown in FIG. 3, controller 50 may be powered by a power supply 56, e.g., an AC-DC power supply that is coupled to line power 58 (e.g., 120-240VAC, as may be provided by a residential electrical circuit), via an electrical outlet and plug, or alternatively, a hard-wired connection. Line power 58 also supplies wireless power transmitter 36 with power. Controller 50 may control wireless power transmitter 36 to selectively activate/deactivate the wireless power transmitter, to regulate the power output of the wireless power transmitter, to communicate data to and/or receive data from wirelessly powered appliance 14, etc. In the illustrated embodiment, wireless power transmitter 36 is compatible with the Ki Kitchen Cordless Standard developed by the Wireless Power Consortium, although other wireless power or charging standards may be used in other embodiments, including, for example, the Qi Wireless Charging Standard also developed by the Wireless Power Consortium. It will be appreciated that the control over wireless power transmitter 36 by controller 50 to emit a wireless power signal would be well within the abilities of those of ordinary skill having the benefit of the instant disclosure.

Wirelessly powered appliance 14 may include a wireless power receiver 60 that, when positioned proximate wireless power transmitter 36, receives a wireless power signal to supply power to the wirelessly powered appliance. Wirelessly powered appliance 14 may also include a controller 62 to operate wireless power receiver 60, as well as to perform other appliance-related functions. Controller 62 may include one or more processors 64 and one or more memories 66 similar to processors and memories 52, 54 of wireless power system 12. Power received by wireless power receiver 60 may be used to also power one or more electrical loads 68, e.g., motors, heating elements, displays, etc., as well as controller 62 itself.

In some embodiments, wirelessly powered appliance 14 may include a user interface 70 to operate the appliance, and, beyond the supply of wireless power, may operate completely independently from wireless power system 12. In other embodiments, however, wireless power system 12 may be functionally integrated with wirelessly powered appliance 14, e.g., such that a user interface 72 of wireless power system 12 is used to display information received from wirelessly powered appliance 14 and/or other status information (e.g., via one or more status lights). Communication between wireless power system 12 and wirelessly powered appliance 14 may be over a Near Field Communication (NFC) wireless link as supported by the Ki standard, or via a separate wired or wireless network.

It may also be desirable to provide one or more sensors 74, 76 for sensing various states associated with wireless power system 12 and/or wirelessly powered appliance 14. For example, one or more temperature sensors and/or current, voltage, induction, and/or power sensors may be used in some embodiments to monitor wireless power transfer and prevent overheating. In addition, in some embodiments, an accelerometer, gyroscope, an inclinometer, and/or other form of motion sensor may be utilized as a sensor 76 to detect movement of wirelessly powered appliance 14. Various sensors associated with the primary functions of wirelessly powered appliance 14 may also be included. Other suitable sensors will be appreciated by those of ordinary skill having the benefit of the instant disclosure. Moreover, as illustrated at 54a and 66a, at least a portion of each of memories 54, 66 may be configured as non-volatile storage (NVS), such that data stored therein is retained even after a loss of power. Among other uses, NVSs 54a, 66a may store various types of state information that may be usable for selectively resuming interrupted operations performed by wirelessly powered appliance 14 after a temporary power loss occurs.

It should be appreciated that wireless power is distinguished from wireless charging in the context of the present disclosure, as while a wireless power system may in some instances provide power to charge a battery of an appliance or other electronic device wirelessly coupled to the wireless power system, such a use is secondary to providing wireless power to operate the appliance, i.e., to provide the primary power supply to the appliance during its active use. As such, a wirelessly powered appliance in many instances may not include any battery or other power storage element capable of independently providing sufficient power to operate the wirelessly powered appliance, such that the wirelessly powered appliance is effectively inoperable unless coupled to a wireless or wired power source (since some wirelessly powered appliances may also be capable of being plugged in). For many wirelessly powered appliances used for cooking for example, high power draw electrical loads such as electric motors, solenoids, heating elements and/or cooling elements may be used, and to the extent any power storage element is present on such a wirelessly powered appliance, it is incapable of sufficiently powering such high power draw electrical loads, such that the wirelessly powered appliance is principally powered through a wireless power system as described herein.

In some embodiments, each controller 50, 62 may operate under the control of an operating system and may execute or otherwise rely upon various computer software applications, components, programs, objects, modules, data structures, etc. In addition, each controller 50, 62 may also incorporate hardware logic to implement some or all of the functionality disclosed herein. Further, in some embodiments, the sequences of operations performed by each controller 50, 62 to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

In addition, in some embodiments, at least a portion of the functionality of wireless power system 12 and/or wirelessly powered appliance 14 may be implemented remote therefrom, e.g., using a user device 78, such as a mobile device, that is in communication with system 12 and/or appliance 14. As such, a controller discussed herein may also be incorporated partially or completely within a user device in some embodiments.

Numerous variations and modifications to wireless power system 12 and wirelessly powered appliance 14 illustrated in FIGS. 1-3 will be apparent to one of ordinary skill in the art, as will become apparent from the description below. Therefore, the invention is not limited to the specific implementations discussed herein.

### Recovery From Power Interruption In Wirelessly Powered Appliance

As noted above, in many scenarios it may be desirable to allow for a wirelessly powered appliance to recover from a loss of power and resume any operations it was performing prior to the power loss. While operational recovery may be useful for practically any appliance, it would particularly be beneficial to allow for operational recovery in appliances that are routinely used unattended, such as slow cookers, air fryers, toaster ovens, pressure cookers, rice cookers, ice cream machines, etc., as otherwise these appliances could be interrupted with a brief power outage and nonetheless restart in an idle state, causing any in-progress operations to be terminated (and potentially any food being prepared to be ruined in the process). On the other hand, it would also not be desirable to automatically resume operation of an appliance that had been intentionally shut off as a result of simply removing the appliance from a wireless power source and returning the appliance to storage.

In the embodiments discussed hereinafter, however, recovery of a wirelessly powered appliance after a power loss may be based on one or more factors that individually or collectively may be used to distinguish between intentional power losses, e.g., power losses that are caused by a user intentionally removing a wirelessly powered appliance from a wireless power system, and unintentional power losses, e.g., as a result of a temporary loss of line power in a household circuit or some other fault in a wireless power system that interrupts the supply of wireless power to the wirelessly powered appliance. In the former instance, it may be determined that due to the user's actions, recovery of an interrupted operation being performed by a wirelessly powered appliance when power was lost should not be resumed, and the wirelessly powered appliance should start up in an idle state. In the latter instance, it may be determined that the unintentional nature of the power loss, the wirelessly powered appliance should automatically resume its prior, interrupted operation once power has been restored to the wirelessly powered appliance.

In the illustrated embodiments, these factors may include one or more of movement of the wirelessly powered appliance, one or more temperatures captured on or in the wirelessly powered appliance, and whether any fault were detected in a wireless power transmitter of a wireless power system that powers the wirelessly powered appliance. In addition, in some embodiments, the duration in which a wirelessly powered appliance has been without power may also be utilized as a factor in combination with one or more of the aforementioned other factors, as in general the longer a wirelessly powered appliance has been without power, the greater the likelihood that the wirelessly powered appliance should not resume any prior interrupted operations.

Movement of the wirelessly powered appliance may be utilized in determining whether to selectively resume an interrupted operation of a wirelessly powered appliance after a power loss in some embodiments. If a wirelessly powered appliance is determined to have been moved, e.g., proximate the time in which power was lost, a greater likelihood exists that the power was lost as a result of the user intentionally removing the wirelessly powered appliance from the wireless power transmitter. If, however, the appliance was not determined to have been moved, a greater likelihood exists that the power loss was unintentional.

Likewise, temperature data captured from a wirelessly powered appliance, e.g., before and after a loss of power, may be used to determine whether to selectively resume an interrupted operation of a wirelessly powered appliance after a power loss in some embodiments. It may be determined, for example, that if the change in temperature is too great, the user intentionally caused the power loss. In addition, in some embodiments, temperature change and/or absolute temperatures may be used to determine whether to resume an interrupted operation for other reasons such as food safety, as, for example, if it is determined that a captured temperature from a wirelessly powered cooking appliance is within a temperature range where bacterial growth can occur, it may not be desirable to resume a cooking operation because the food being cooked may have been at an unsafe temperature for an indeterminate period of time.

Detected faults in a wireless power transmitter of a wireless power system that powers a wirelessly powered appliance may also be used to determine whether to selectively resume an interrupted operation of a wirelessly powered appliance after a power loss in some embodiments. It will be appreciated that, as compared to an intentional power loss caused by moving a wirelessly powered appliance away from a wireless power transmitter, a fault in the wireless power transmitter itself that causes a loss of power to the wirelessly powered appliance is more likely associated with an unintentional power loss from which it may be appropriate to automatically resume any prior interrupted operations. A fault, in this regard, may be considered in some instances to be a technical issue with the wireless power transmitter or the overall wireless power system within which the wireless power transmitter is disposed, e.g., a software error that causes the wireless power system to reset itself and temporarily interrupt the supply of wireless power and/or interrupt wireless communications with the wirelessly powered appliance. In some instances, however, a fault may also be considered to be a fault in the line power that powers the wireless power system, e.g., a triggered circuit breaker, a triggered ground fault circuit interrupter, or a temporary loss of line power due to weather or maintenance activities.

Now turning to FIG. 4, and as noted above, the duration of a power loss may be used in some embodiments as a factor in determining whether to resume an interrupted operation in a wirelessly powered appliance. In some embodiments, duration may be determined using an RC timer circuit 80, which includes a power supply (e.g., 5V) that is fed to the drain of an N-channel MOSFET Q1 (e.g., a DMN3731U MOSFET), and that is coupled to a gate of MOSFET Q1 through a diode D1 and resistor R1 (e.g., 100 Ω) The gate is further coupled to ground through a capacitor C1 and resistor R2, while a source of MOSFET Q1 is coupled to ground through a resistor R3 (e.g., 10 kΩ). Capacitor C1 and resistor R2 define a time constant that controls how long stored charge in capacitor will be discharged, such that the voltage at the source of MOSFET Q1 will decay at a known rate after a loss of power occurs. In one embodiment, for example, a 120 uF capacitor and 1 MΩ resistor may be used to provide a voltage at the source of MOSFET Q1 that fully dissipates after about 180 seconds. Thus, by coupling the source of MOSFET Q1 to an analog-to-digital converter of controller 62, the amount of time that has elapsed since power was lost by wirelessly powered appliance 14 may be determined, with zero voltage indicating that at least a maximum time has passed. Alternatively, the source of MOSFET Q1 may be coupled to a digital input of controller 62 in some embodiments.

It will be appreciated that other circuit components may be used to lengthen or shorten the maximum duration that can be tracked after a power loss. Moreover, other manners of determining duration may be used in other embodiments, e.g., a real time clock circuit, or a timing circuit that outputs a digital signal to controller 62. Therefore, the invention is not limited to the specific implementations discussed herein.

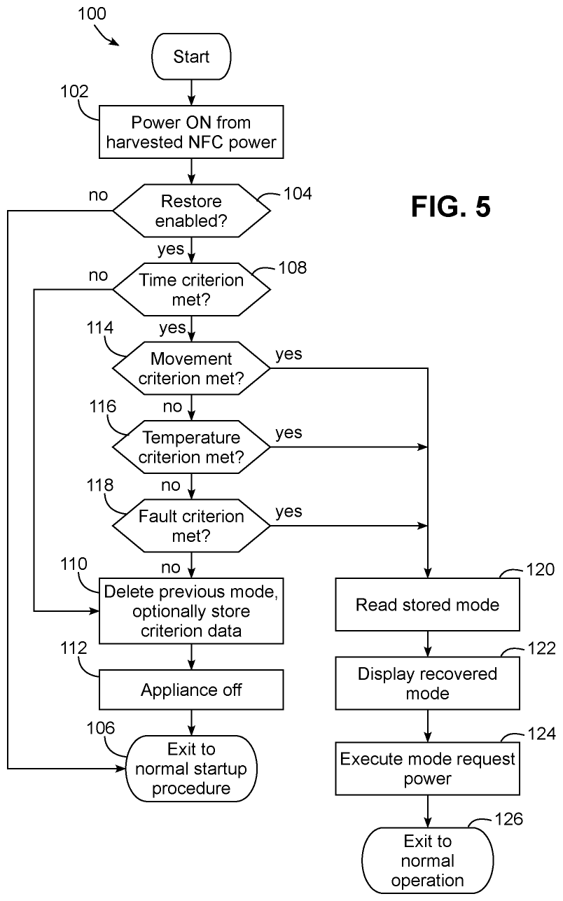

Now turning to FIG. 5, an example operational sequence 100 is illustrated for use in determining whether to resume a prior interrupted operation in a wirelessly powered appliance. Operational sequence 100 may be initiated, for example, during a startup of a wirelessly powered appliance, and may begin in block 102 by powering on the appliance from harvested NFC power (e.g., based upon the aforementioned Ki wireless power standard). Block 104 next determines whether restore is enabled for the wirelessly powered appliance. For example, it may be desirable in some embodiments for a restore feature to be selectively enabled by a user, e.g., via appliance settings. In other embodiments, a restore feature may be based on the state of a wirelessly powered appliance when power was lost, e.g., such that restore is enabled only when the wirelessly powered appliance was actively being used when the power was lost by the wirelessly powered appliance. In this regard, a determination of whether restore is enabled may be based on a determination of whether a previous operational mode of the wirelessly powered appliance is stored in non-volatile storage, indicating that the wirelessly powered appliance was in a non-idle mode when power was lost.

If the restore feature is not enabled, control passes to block 106 to exit to a normal startup procedure, e.g., to establish communications with the wireless power system and initialize the wirelessly powered appliance in an idle state. Otherwise, block 104 passes control to block 108 to first determine if a time criterion has been met, e.g., based upon a determination of the duration since the wirelessly powered appliance was last powered on. As noted above, for example, where a circuit such as circuit 80 of FIG. 4 is used, the time criterion may be based on, for example, whether less than a predetermined time period has elapsed since power was lost, such that if more than the predetermined time period has elapsed, control passes to block 110 to delete any previous operational mode stored for the wirelessly powered appliance (e.g., in NVS 66a) and then to block 112 to turn the wirelessly powered appliance to an “OFF” state. In addition, in some embodiments, it may also be desirable to store criteria data including which criterion or criteria failed, and in some instances, additional information as to why each criterion failed in block 110. By doing so, the criterion data may be used to provide user feedback, e.g., on user interface 70 or via an app, as to why the appliance did not resume the interrupted operation. Control then passes to block 106 to exit to the normal startup procedure.

It will be appreciated that the time criterion may vary in different embodiments, e.g., for different types of wirelessly powered appliances. For example, for an appliance such as an air fryer, a maximum duration of about 1 minute may be suitable, while for a rice cooker or toaster oven, a maximum duration of about 2 minutes may be suitable, and for a slow cooker, as maximum duration of about 20 minutes may be suitable. For other appliances and applications, other time criteria may be used.

Returning to block 108, if the time criterion is met, control passes to blocks 114, 116 and 118 to determine if any of the movement, temperature, or fault-related factors are met for resuming an interrupted operation with the wirelessly powered appliance. The determinations made in blocks 114, 116, and 118 may be based in part on stored data maintained in NVS 66a, and stored, for example, in the manners discussed below in connection with FIGS. 7-9.

Block 114, for example, determines whether a movement criterion is met. In some embodiments, the movement criterion may require a determination that the wirelessly powered appliance was not in motion when power was lost, such that if it is determined that the wirelessly powered appliance was in motion when power was lost, no recovery will be performed. Motion may be determined, for example, by accessing movement data captured by a motion sensor (e.g., an accelerometer and/or gyroscope implemented as a sensor 76 in wirelessly powered appliance 14).

Block 116 determines whether a temperature criterion is met. In some embodiments, the temperature criterion may be based on one or more stored temperatures in NVS 66a, while in other embodiments, the temperature criterion may be based on a current temperature captured on or in the wirelessly powered appliance (e.g., in a temperature sensor implemented as a sensor 76 of wirelessly powered appliance 14). In still other embodiments, a change in temperature, determined from both a current temperature and a stored temperature, may be used. A suitable temperature criterion, for example, for a cooking appliance may be based on whether the current temperature (e.g., internally in the cooking appliance) meets a predetermined threshold, such as above 140 degrees Fahrenheit, which is a temperature generally associated with food safety. Another suitable temperature criterion, for example, is whether the temperature has decreased from a stored temperature less than a predetermined amount (e.g., 30 degrees). Other suitable temperature criteria will be apparent to those of ordinary skill having the benefit of the instant disclosure.

Block 118 determines whether a fault criterion has been met. In some embodiments, the fault criterion may be based on fault data that is stored prior to startup of the wirelessly powered appliance. As will be discussed in greater detail below, in some embodiments, the fault data may be stored in NVS 54a of wireless power system 12 and communicated to wirelessly powered appliance 14 during startup in some embodiments, while in other embodiments, fault data may be communicated from wireless power system 12 to wirelessly powered appliance 14 and stored in NVS 66a upon a detection of loss of power in the wireless power transmitter, so long as some indication of a fault with the wireless power transmitter is available when determining whether to recover an interrupted operation.

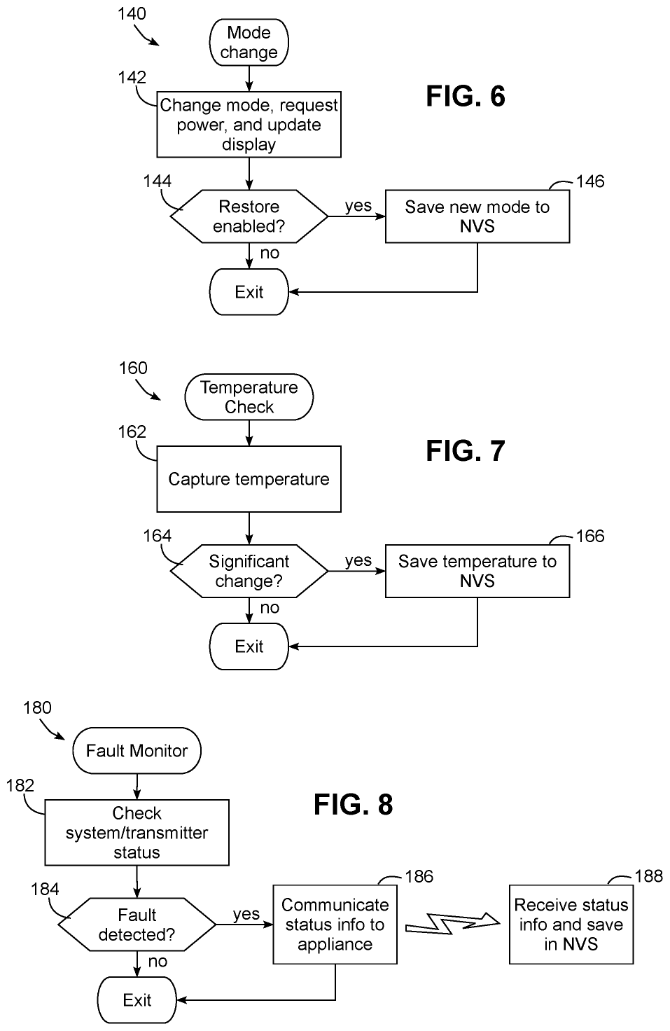

If none of the criteria in blocks 114-118 are met, control passes to block 110 to delete the previous operational mode (and optionally store criterion data), turn off the appliance, and exit to a normal startup procedure. If, however, any of the criteria is determined to be met, control instead passes to block 120 to recover the interrupted operation. Specifically, block 120 reads the stored operational mode from NVS 66a (which is stored in the manner discussed below in connection with FIG. 6) to obtain the state of the wirelessly powered appliance when power was lost. In different embodiments, different operational mode data may be stored, e.g., which function was active, which options were enabled, one or more temperature setpoints, progress data indicating how long the operation was performed and/or how much time remains in the operation, or any other data that may be used to resume the previous operational mode of the wirelessly powered appliance.

Next, block 122 displays the recovered mode on user interface 70 of wirelessly powered appliance 14, and block 124 executes a power request for the operational mode, e.g., to negotiate with the wireless power system to receive the necessary power to continue with the interrupted operation. Control then passes to block 126 to exit to normal operation of the wirelessly powered appliance, with the interrupted operation resumed.

It will be appreciated that, in the embodiment illustrated in FIG. 5, resumption of an interrupted operation requires meeting a time criterion along with meeting one or more of a movement criterion, temperature criterion and fault criterion. In other embodiments, however, other logic flows may be used. For example, in some embodiments, all four criteria may need to be met, while in other embodiments, only one of the four criteria may need to be met. The order in which criteria may be checked may be varied in other embodiments, and one or more of the criteria may be omitted from other embodiments. Practically any combination of any of the aforementioned criteria may be used in other embodiments, as will be appreciated by those of ordinary skill having the benefit of the instant disclosure, so the invention is not limited to the particular logic flow illustrated in FIG. 5.

FIG. 6 illustrates an example operational sequence 140 for storing the operational mode of the wirelessly-powered appliance in NVS 66a. Sequence 140 may be executed, for example, in response to any mode change in the wirelessly powered appliance, and may begin in block 142 by changing the operational mode, requesting the necessary power for the desired operational mode, and updating the display of the wirelessly powered appliance accordingly. For example, a change in operational mode may result from starting or stopping an operation with the wirelessly powered appliance, or in some instances, changing an ongoing operation (e.g., changing a temperature setpoint, a fan speed, etc.). Block 144 next determines if restore is enabled, e.g., based on a user setting or alternatively, based on whether the new mode is recoverable, or at least a non-idle mode. If not, sequence 140 is complete, otherwise, control passes to block 146 to save the new operational mode in NVS 66a. As noted above, various types of operational mode data suitable for use in restoring or recovering the operational mode after a power loss may be stored in block 146, as will be appreciated by those of ordinary skill having the benefit of the instant disclosure. Once the operational mode data is stored, sequence 140 is complete.

FIG. 7 illustrates an example operational sequence 160 for storing temperature data in NVS 66a, which may be performed, for example, on a periodic basis. Sequence 160 may begin in block 162 by capturing a temperature on or in the wirelessly powered appliance, and block 164 may determine whether a significant temperature change has occurred (e.g., if the difference between the current temperature and a temperature stored in NVS 66a meets a predetermined threshold). If not, sequence 160 is complete, otherwise, control passes to block 166 to save the captured temperature to NVS 66a, and sequence 160 is thereafter complete.

Operational sequences 140 and 160 in the illustrated embodiment are performed by wirelessly powered appliance 14. FIG. 8, however, illustrates an example operational sequence 180 for storing fault temperature data in NVS 66a, which may be performed predominantly in wireless power system 12 and on a periodic basis. Sequence 180 may begin in block 182 by checking the status of the wireless power system and/or the wireless power transmitter in particular. Block 184 may determine if a fault is detected, and if not, sequence 180 may be complete. If a fault is detected, however, control passes to block 186 to communicate, as fault data, status information associated with the fault to wirelessly powered appliance 12, which receives the status information and stores it in NVS 66a in block 188. Sequence 180 is then complete.

In the alternative, rather than communicate the status information upon detection of a fault, the status information may be stored in wireless power system 12, e.g., in NVS 54a. The stored data may then be communicated to wirelessly powered appliance 14 during startup of wirelessly powered appliance 14 after a power loss.

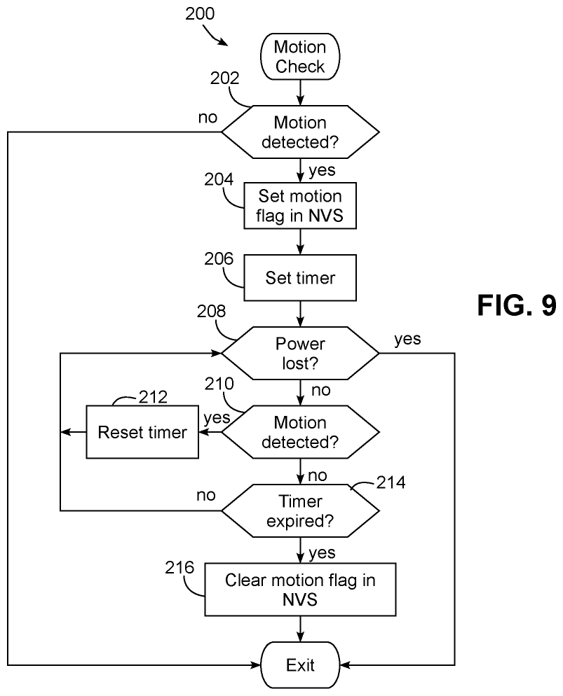

FIG. 9 next illustrates an operational sequence 200 for storing movement data for the wirelessly powered appliance. Operational sequence 200 may be executed on a periodic basis and is generally used to detect motion of the wirelessly powered appliance and store a flag indicating such motion in NVS 66a. Operational sequence 200 is also, however, capable of detecting when motion has concluded, such that any motion that does not result in a removal of power from the wirelessly powered appliance will be ignored.

First, in block 202, it is determined whether motion has been detected, e.g., using an accelerometer and/or gyroscope. If not, sequence 200 is complete. Otherwise, control passes to block 204 to set a motion flag in NVS 66a, and then to block 206 to start a timer that controls how long a lack of motion will be used to determine that the wirelessly powered appliance is no longer in motion and that the motion flag can be cleared.

Block 208 next detects any power loss, which terminates sequence 200. It will be appreciated that if a power loss occurs at this point, the motion flag will be set in NVS 66a, so the wirelessly powered appliance can later determine that it was in motion when power was lost during the next startup operation.

If power is not lost, block 208 passes control to block 210 to determine if motion is still detected. If so, control passes to block 212 to reset the timer, and then return control to block 208. If not, however, control passes to block 214 to determine if the timer has expired. If not, control returns to block 208, but if so, control passes to block 216 to clear the motion flag in NVS 66a, and terminate sequence 200. Therefore, it will be appreciated that if power is not lost during the duration of the timer after the last movement has been detected, the wirelessly powered appliance will be determined to not be in motion, and the motion flag in NVS 66a will be cleared.

Various alternatives may be used in different embodiments. For example, movement, temperature and/or fault factors may be used individually, rather than together, in some embodiments. Moreover, different manners of determining such factors may also be used in different embodiments.

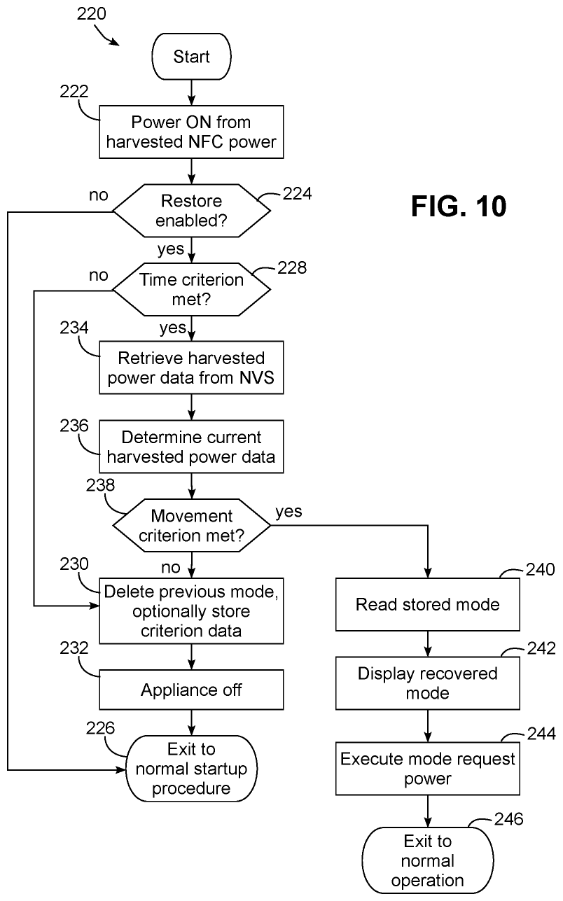

FIG. 10, for example, illustrates an operational sequence 220 for use in determining whether to resume a prior interrupted operation in a wirelessly powered appliance based on a movement criterion, where that movement criterion is based on analysis of the harvested voltage from the wireless power system. It will be appreciated, in particular, that based upon the alignment of the wireless power receiver of a wirelessly powered appliance with the wireless power transmitter of a wireless power system, the electromagnetic coupling, and the power transfer efficiency of the wireless power signal may vary. Thus, by comparing harvested power data before and after a power loss, a change in alignment, and thus a change in the position in the wirelessly powered appliance relative to the wireless power transmitter may be detected. Accordingly, if a user has moved the wirelessly powered appliance away from the wireless power transmitter and later moved the wirelessly powered appliance back, but at a slightly different position, differences in the harvested power data may indicate such movement.

Harvested power data, in some embodiments, includes a harvested voltage, e.g., of the harvested NFC power. Other indicators of the relative alignment, however, may be used in other embodiments, as will be appreciated by those of ordinary skill having the benefit of the instant disclosure. Such harvested power data may be stored on a periodic basis during use of the wirelessly powered appliance, such that it is maintained in NVS 66a should power be lost and then restored, and is available for comparison to the harvested power data associated with the current alignment of the wirelessly powered appliance with the wireless power transmitter.

Operational sequence 220 may be initiated, for example, during a startup of a wirelessly powered appliance, and may begin in block 222 by powering on the appliance from harvested NFC power. Block 224 next determines whether restore is enabled for the wirelessly powered appliance, and if not control passes to block 226 to exit to a normal startup procedure. Otherwise, block 224 passes control to block 228 to first determine if a time criterion has been met, e.g., as discussed above in connection with FIG. 5. As such, if the time criterion is not met, control passes to block 230 to delete any previous operational mode stored for the wirelessly powered appliance (e.g., in NVS 66a) and optionally store criterion data, and then to block 232 to turn the wirelessly powered appliance to an “OFF” state. Control then passes to block 226 to exit to the normal startup procedure.

Returning to block 228, if the time criterion is met, control passes to block 234 to retrieve the stored harvested power data (e.g., a harvested voltage) from NVS 66a, and to block 236 to determine current harvested power data (e.g., a harvested voltage). Block 238 then determines if a movement criterion is met, e.g., if a sufficient difference exists between the stored (prior) harvested power data and the current harvested power data to indicate that the wirelessly powered appliance has been moved. If the movement criterion has not been met (i.e., the wirelessly powered appliance has been determined to have been moved), control passes to block 230 to delete the previous operational mode (and optionally store criterion data), turn off the appliance, and exit to a normal startup procedure. If, however, the movement criterion has been met (i.e., the wirelessly powered appliance has been determined to not have been moved), control passes to blocks 240, 242 and 244 to recover the interrupted operation. Specifically, block 240 reads the stored operational mode from NVS 66a to obtain the state of the wirelessly powered appliance when power was lost. Block 242 displays the recovered mode on user interface 70 of wirelessly powered appliance 14, and block 244 executes a power request for the operational mode, e.g., to negotiate with the wireless power system to receive the necessary power to continue with the interrupted operation. Control then passes to block 246 to exit to normal operation of the wirelessly powered appliance, with the interrupted operation resumed.

It will be appreciated that other manners of detecting movement may also be used in other embodiments. For example, other manners of determining the position of a wirelessly powered appliance relative to a wireless power transmitter may be used, such that a comparison of relative positions before and after a power loss may be used to determine whether movement occurred.

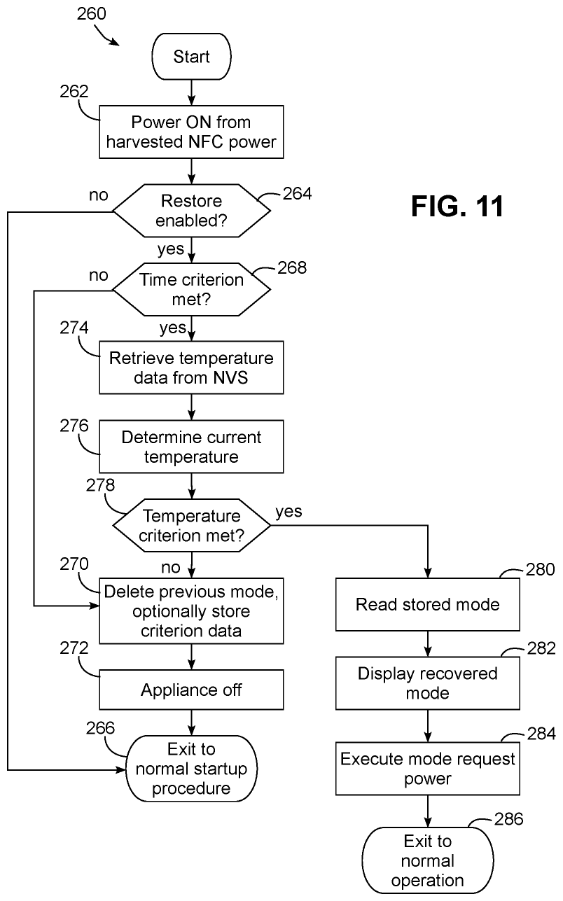

FIG. 11 next illustrates an operational sequence 260 for use in determining whether to resume a prior interrupted operation in a wirelessly powered appliance based on a temperature criterion, where that temperature criterion is based on a temperature change from before a power loss to after. Operational sequence 260 may be initiated, for example, during a startup of a wirelessly powered appliance, and may begin in block 262 by powering on the appliance from harvested NFC power. Block 264 next determines whether restore is enabled for the wirelessly powered appliance, and if not control passes to block 266 to exit to a normal startup procedure. Otherwise, block 264 passes control to block 268 to first determine if a time criterion has been met, e.g., as discussed above in connection with FIG. 5. As such, if the time criterion is not met, control passes to block 270 to delete any previous operational mode stored for the wirelessly powered appliance (e.g., in NVS 66a) and optionally store criterion data, and then to block 272 to turn the wirelessly powered appliance to an “OFF” state. Control then passes to block 266 to exit to the normal startup procedure.

Returning to block 268, if the time criterion is met, control passes to block 274 to retrieve the stored temperature data from NVS 66a, and to block 276 to determine current temperature data. Block 278 then determines if a temperature criterion is met, e.g., if the difference between the stored (prior) temperature data and the current temperature data is below a predetermined threshold. If the temperature criterion has not been met (e.g., too great of a temperature delta exists), control passes to block 270 to delete the previous operational mode (and optionally store criterion data), turn off the appliance, and exit to a normal startup procedure. If, however, the temperature criterion has been met, control passes to blocks 280, 282 and 284 to recover the interrupted operation. Specifically, block 280 reads the stored operational mode from NVS 66a to obtain the state of the wirelessly powered appliance when power was lost. Block 282 displays the recovered mode on user interface 70 of wirelessly powered appliance 14, and block 284 executes a power request for the operational mode, e.g., to negotiate with the wireless power system to receive the necessary power to continue with the interrupted operation. Control then passes to block 286 to exit to normal operation of the wirelessly powered appliance, with the interrupted operation resumed.

Temperature data may be used in other manners in other embodiments. For example, temperature data (and in particular, the change in temperature over time when a known amount of energy is supplied to food) may be used to determine a thermal mass of the food in a cooking appliance to determine whether food has been added or removed from an appliance, which may be an indicator that a power loss was not unintentional or temporary in nature.

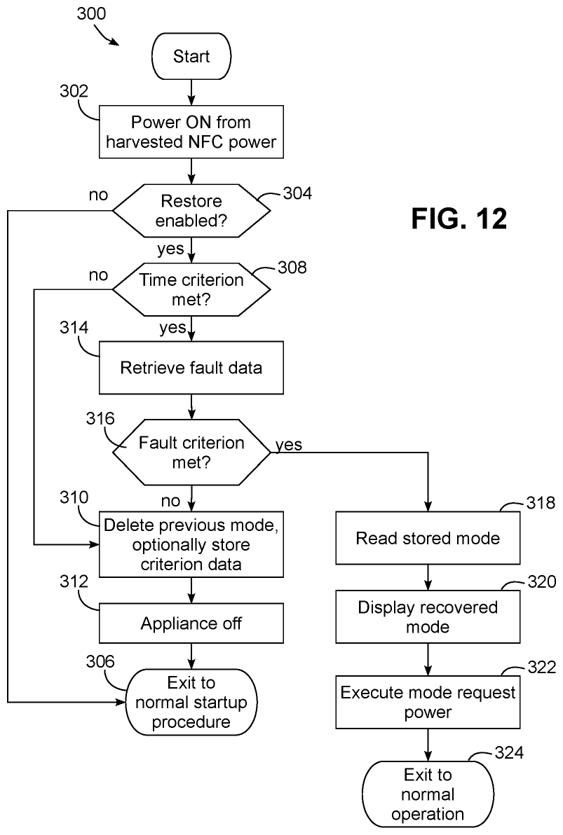

FIG. 12 next illustrates an operational sequence 300 for use in determining whether to resume a prior interrupted operation in a wirelessly powered appliance based on a fault criterion, where that fault criterion is based on whether a power loss by the wirelessly powered appliance was due to a loss of power by the wireless power transmitter. Operational sequence 300 may be initiated, for example, during a startup of a wirelessly powered appliance, and may begin in block 302 by powering on the appliance from harvested NFC power. Block 304 next determines whether restore is enabled for the wirelessly powered appliance, and if not control passes to block 306 to exit to a normal startup procedure. Otherwise, block 304 passes control to block 308 to first determine if a time criterion has been met, e.g., as discussed above in connection with FIG. 5. As such, if the time criterion is not met, control passes to block 310 to delete any previous operational mode stored for the wirelessly powered appliance (e.g., in NVS 66a) and optionally store criterion data, and then to block 312 to turn the wirelessly powered appliance to an “OFF” state. Control then passes to block 306 to exit to the normal startup procedure.

Returning to block 308, if the time criterion is met, control passes to block 314 to retrieve the fault data. As noted above, in some embodiments, the fault data may be retrieved from NVS 66a, assuming the fault data is communicated to the wirelessly powered appliance by the wireless power system and stored in NVS 66a prior to full loss of power. In other embodiments, however, the wireless power system may store its own fault data in NVS 54a and later communicate that fault data to the wirelessly powered appliance during the startup procedure. Thus, in the latter instance, block 314 may retrieve the fault data from the wireless power system.

Block 316 next determines if a fault criterion is met, e.g., if the power loss is determined to be a result of a loss of power to the wireless power transmitter. If the fault criterion has not been met (e.g., no fault existed when the power loss occurred), control passes to block 310 to delete the previous operational mode (and optionally store criterion data), turn off the appliance, and exit to a normal startup procedure. If, however, the temperature criterion has been met, control passes to blocks 318, 320, and 322 to recover the interrupted operation. Specifically, block 318 reads the stored operational mode from NVS 66a to obtain the state of the wirelessly powered appliance when power was lost. Block 320 displays the recovered mode on user interface 70 of wirelessly powered appliance 14, and block 322 executes a power request for the operational mode, e.g., to negotiate with the wireless power system to receive the necessary power to continue with the interrupted operation. Control then passes to block 324 to exit to normal operation of the wirelessly powered appliance, with the interrupted operation resumed.

It will be appreciated that, while certain features may be discussed herein in connection with certain embodiments and/or in connection with certain figures, unless expressly stated to the contrary, such features generally may be incorporated into any of the embodiments discussed and illustrated herein. Moreover, features that are disclosed as being combined in some embodiments may generally be implemented separately in other embodiments, and features that are disclosed as being implemented separately in some embodiments may be combined in other embodiments, so the fact that a particular feature is discussed in the context of one embodiment but not another should not be construed as an admission that those two embodiments are mutually exclusive of one another. Various additional modifications may be made to the illustrated embodiments consistent with the invention. Therefore, the invention lies in the claims hereinafter appended.

What is claimed is:

1. An apparatus, comprising:
one or more processors; and
one or more memories storing instructions that, when executed by the one or more processors, selectively resume an interrupted operation of a wirelessly powered appliance after an unintentional power loss by, during startup of the wirelessly powered appliance:
determining the interrupted operation being performed by the wirelessly powered appliance when power was lost by the wirelessly powered appliance;
determining whether the power was lost by the wirelessly powered appliance as a result of movement of the wirelessly powered appliance;
determining whether to resume the determined interrupted operation based at least in part on the determination of whether the power was lost by the wirelessly powered appliance as the result of movement of the wirelessly powered appliance; and
causing the wirelessly powered appliance to automatically resume the interrupted operation based at least in part on the determination of whether to resume the determined interrupted operation.

2. The apparatus of claim 1, wherein at least one of the one or more memories and at least one of the one or more processors are disposed in the wirelessly powered appliance.

3. The apparatus of claim 1, wherein at least one of the one or more memories and at least one of the one or more processors are disposed in a wireless power system that supplies wireless power to the wirelessly powered appliance.

4. The apparatus of claim 1, further comprising non-volatile storage, wherein the instructions are configured to selectively resume the interrupted operation of the wirelessly powered appliance after the unintentional power loss further by storing movement data captured by a motion sensor of the wirelessly powered appliance during performance of the interrupted operation and prior to the startup of the wirelessly powered appliance, and wherein the instructions are configured to determine whether the power was lost by the wirelessly powered appliance as a result of movement of the wirelessly powered appliance by accessing the non-volatile storage during startup of the wirelessly powered appliance.

5. The apparatus of claim 4, wherein the motion sensor includes an accelerometer, a gyroscope, and/or an inclinometer.

6. The apparatus of claim 1, further comprising non-volatile storage, wherein the instructions are configured to selectively resume the interrupted operation of the wirelessly powered appliance after the unintentional power loss further by storing first harvested power data associated with alignment of the wireless power transmitter and a wireless power receiver of the wirelessly powered appliance prior to the loss of power of the wirelessly powered appliance, and wherein the instructions are configured to determine whether the power was lost by the wirelessly powered appliance as a result of movement of the wirelessly powered appliance by accessing the non-volatile storage during startup of the wirelessly powered appliance to compare the first harvested power data with second harvested power data associated with alignment of the wireless power transmitter and a wireless power receiver of the wirelessly powered appliance after the loss of power of the wirelessly powered appliance.

7. The apparatus of claim 1, further comprising non-volatile storage, wherein the instructions are configured to selectively resume the interrupted operation of the wirelessly powered appliance after the unintentional power loss further by storing operational state data for the wirelessly powered appliance during performance of the interrupted operation and prior to the startup of the wirelessly powered appliance, and wherein the instructions are configured to determine the interrupted operation being performed by the wirelessly powered appliance when power was lost by the wirelessly powered appliance by accessing the non-volatile storage during startup of the wirelessly powered appliance.

8. The apparatus of claim 1, wherein the instructions are configured to determine whether to resume the determined interrupted operation based at least in part on the determination of whether the power was lost by the wirelessly powered appliance as a result of movement of the wirelessly powered appliance by:
determining to resume the determined interrupted operation if the wirelessly powered appliance is determined to not have been in motion when power was lost by the wirelessly powered appliance; and
determining to not resume the determined interrupted operation if the wirelessly powered appliance is determined to have been in motion when power was lost by the wirelessly powered appliance.

9. The apparatus of claim 1, wherein the wirelessly powered appliance is a kitchen appliance including at least one electrical load, wherein the at least one electrical load includes an electric motor, a solenoid, a cooling element, or a heating element, and wherein the interrupted operation uses the at least one electrical load during performance of the interrupted operation.

10. The apparatus of claim 1, wherein the instructions are further configured to determine a duration from when power was lost by the wirelessly powered appliance, and wherein the instructions are configured to determine whether to resume the determined interrupted operation further based at least in part on the determined duration.

11. The apparatus of claim 1, wherein the instructions are further configured to determine a temperature on or in the wirelessly powered appliance and determine whether the power loss was a result of a fault in a wireless power transmitter that supplies power to the wirelessly powered appliance, and wherein the instructions are configured to determine whether to resume the determined interrupted operation further based at least in part on the determined temperature and the determination of whether the power loss was the result of a fault in the wireless power transmitter.

12. An apparatus, comprising:
one or more processors; and
one or more memories storing instructions that, when executed by the one or more processors, selectively resume an interrupted operation of a wirelessly powered appliance after an unintentional power loss by, during startup of the wirelessly powered appliance:
determining the interrupted operation being performed by the wirelessly powered appliance when power was lost by the wirelessly powered appliance;
determining a temperature on or in the wirelessly powered appliance;
determining whether to resume the determined interrupted operation based at least in part on the determined temperature; and
causing the wirelessly powered appliance to automatically resume the interrupted operation based at least in part on the determination of whether to resume the determined interrupted operation.

13. The apparatus of claim 11, wherein the interrupted operation is a cooking operation that heats food using the wirelessly powered appliance.

14. The apparatus of claim 13, wherein the determined temperature is a temperature captured by a temperature sensor of the wirelessly powered appliance after power was lost by the wirelessly powered appliance.

15. The apparatus of claim 14, wherein the instructions are configured to determine whether to resume the determined interrupted operation based at least in part on the determined temperature by determining to resume the determined interrupted operation in response to the determined temperature meeting a predetermined temperature threshold.

16. The apparatus of claim 15, wherein the predetermined temperature threshold is associated with a food safety temperature.

17. The apparatus of claim 14, wherein the temperature is a first temperature, wherein the instructions are further configured to determine a second temperature on or in the wirelessly powered appliance before power was lost by the wirelessly powered appliance, and wherein the instructions are configured to determine whether to resume the determined interrupted operation based at least in part on the determined temperature by determining a temperature change from between the first and second temperatures.

18. An apparatus, comprising:
one or more processors; and
one or more memories storing instructions that, when executed by the one or more processors, selectively resume an interrupted operation of a wirelessly powered appliance after an unintentional power loss by, during startup of the wirelessly powered appliance:
determining the interrupted operation being performed by the wirelessly powered appliance when power was lost by the wirelessly powered appliance;
determining whether the power loss was a result of a fault in a wireless power transmitter that supplies power to the wirelessly powered appliance;
determining whether to resume the determined interrupted operation based at least in part on the determination of whether the power loss was the result of a fault in the wireless power transmitter; and
causing the wirelessly powered appliance to automatically resume the interrupted operation based at least in part on the determination of whether to resume the determined interrupted operation.

19. The apparatus of claim 18, wherein the instructions are configured to determine whether the power loss was the result of a fault in a wireless power transmitter that supplies power to the wirelessly powered appliance by determining that the power loss was the result of a power loss by the wireless power transmitter.

20. The apparatus of claim 19, further comprising non-volatile storage, wherein the instructions are configured to selectively resume the interrupted operation of the wirelessly powered appliance after the unintentional power loss further by storing fault data associated with the fault in the wireless power transmitter prior to the startup of the wirelessly powered appliance, and wherein the instructions are configured to determine whether the power loss was the result of a fault in the wireless power transmitter by accessing the non-volatile storage during startup of the wirelessly powered appliance.
